(19) United States
(12) Patent Application Publication
(10) Pub. No.: US 2007/0045411 A1
(43) Pub. Date: Mar. 1, 2007

(54) PAY FOR USE POWER OUTLET

(76) Inventors: Stephen Honingford, Rochester Hills, MI (US); Vittorio Debenedetti, Warren, MI (US); Nino Debenedetti, Sterling Heights, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/468,167

(22) Filed: Aug. 29, 2006

Related U.S. Application Data
(60) Provisional application No. 60/712,212, filed on Aug. 29, 2005.

(51) Int. Cl. G06F 7/08; G06F 17/00

(52) U.S. Cl. 235/381; 235/375

(57) ABSTRACT

A pay for use power outlet may include a housing and a power management system disposed within the housing. An electrical receptacle or ground fault interrupt plug may also be positioned on the housing or remotely from the housing to provide a user with a source of electrical current.

### CROSS-REFERENCE TO RELATED APPLICATIONS

The present application claims priority from U.S. Provisional Patent Application No. 60/712,212, filed Aug. 29, 2005, the disclosure of which is incorporated herein by reference.

### BACKGROUND OF THE INVENTION

1. Field of the Invention

The present invention concerns a pay for use power outlet apparatus. More specifically, disclosed herein is a power dispensing apparatus that may be used in commercial facilities including transportation terminals (e.g., subway, train stations, bus stations and airports), conference and convention centers or rooms, and in non-commercial facilities such as libraries so that such facilities may provide patrons with a ready source for electrical current (for running computers or the like) on a pay for use basis.

2. Reference to Related Art

Previous efforts to provide the public with a coin-operated electrical outlet included the Watt Vendor electricity dispenser. The Watt Vendor included a housing that contained an onboard electrical outlet receptacle, a coin slot and bank and a timer switch for controlling the flow of current.

Another power dispensing apparatus was disclosed by Japanese Publication No. 11-135200, which was published on May 21, 1999 and was directed to an AC Adaptor with Coin Timer. The AC Adaptor featured an electrical outlet, a coin slot and a coin discharge outlet.

Finally, U.S. Pat. No. 4,351,028 issued on Sep. 21, 1982 and was directed to Meters for Measuring Electrical Energy Consumption. Specifically, the meter described could be set up to operate using coins or tokens, although its primary use was as a residential or consumer type electrical meter. The meter included data processing and collection means. A modem could also be provided to permit a utility to male use of the collected data.

### SUMMARY OF THE INVENTION

A pay for use power outlet is disclosed that may be integrated into a facility electrical system so that users of the facility have access to a source of electricity and the facility may have the opportunity to recover its costs or profit from the providing of electricity to the public. The pay for use power outlet may include a housing, a power management system disposed within the housing, a collection apparatus in communication with the power management system and an electrical outlet in electrical communication with the power management system.

The electrical outlet may be positioned on or remote from the housing and may include a ground fault interrupter plug. Further, the collection apparatus may include one or combination of devices including a coin slot and bank, a card reader, a keypad, and a radio frequency identification (RFID) reader.

The power management system may include an AC to DC switching power supply, a theft sensor, a memory apparatus and a transceiver apparatus. The AC to DC switching power supply may have an auto ranging input supply with a range of 90-260 VAC.

Finally, a light display and graphic display may be positioned on the housing. The light display may operate to indicate the amount of time electrical current will flow to the electrical outlet.

### BRIEF DESCRIPTION OF THE DRAWING

Reference will now be made to the attached drawing wherein like reference numerals refer to like parts throughout and wherein:

FIG. 1 is a perspective view of an embodiment of a pay for use power outlet;

FIG. 2 is a perspective view showing a pay for use power outlet positioned proximate a seat;

FIG. 3 is a perspective view showing a pay for use power outlet spaced a distance from an associated receptacle, which is positioned proximate a seat; and

FIG. 4 is a circuit diagram for an embodiment of a pay for use power outlet.

### DETAILED DESCRIPTION OF THE INVENTION

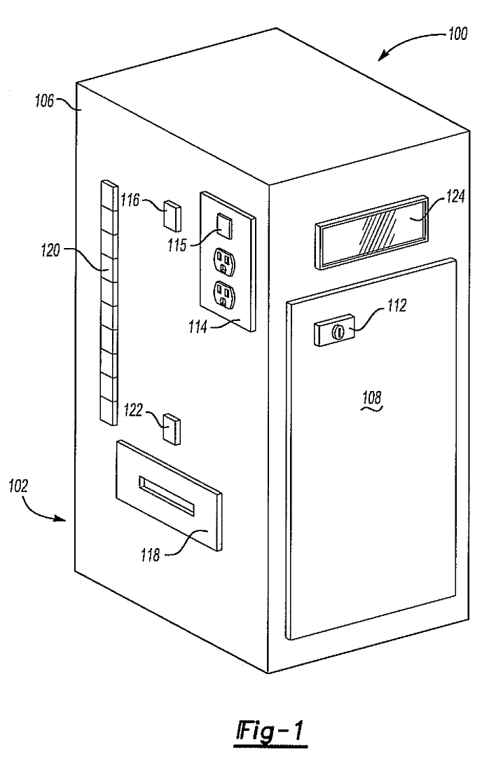

Referring to FIGS. 1-4, an embodiment of a pay for use power outlet 100 may include a housing 102 and a power management system 104 disposed within the housing 102. The housing, 102 may include a display panel 106 and a removable panel 108 (or alternatively a hinged door) that permits a user access to the power management system 104 positioned within an interior (not shown) of the housing 102. A barrel style security lock or key switch 112 may be positioned on the housing 102 proximate the panel 108 to restrict removal of the panel 108. Further, an electrical receptacle or ground fault interrupt plug 114 (described below) may also be positioned on or near the display panel 106 to provide a user with the means to plug his or her electrical device into the outlet 100. In this regard, the display panel 106 or the ground fault interrupt plug 114 may also feature a ground fault interrupt reset light 116 (described below). The outlet 100 may also be hardwired into an electrical power source (such as a transportation terminal's electrical system) or may include a corded plug (not shown) or other means that would permit it to be easily connected or disconnected from an electrical power source.

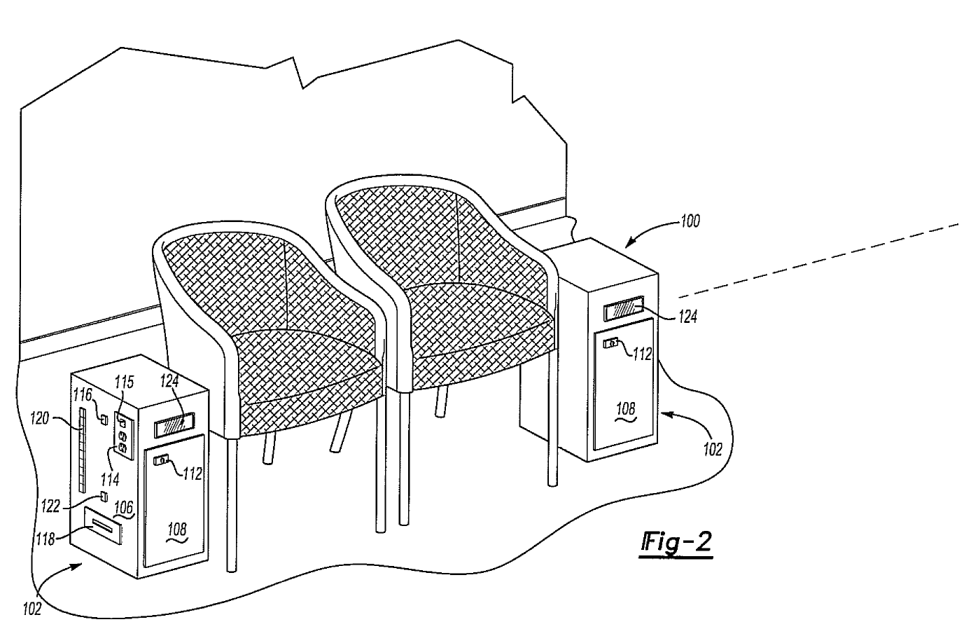

Referring now to FIG. 2, one or more pay for use power outlets 100 may be positioned proximate seats that are positioned in a commercial or non-commercial facility. For example, a power outlet may be positioned proximate a seat that is located in a transportation terminal (e.g., subway, train stations, bus stations and airports gates). Indeed, positioning one or more power outlets at a transportation terminal may be particularly useful since such facilities are frequented by travelers (i.e., business travelers) who often carry with them one or more electronic device (e.g., a laptop computer) and thus have a great need for electrical power. However, it has been applicant's experience that sources for electrical power are often difficult to locate in transportation facilities.

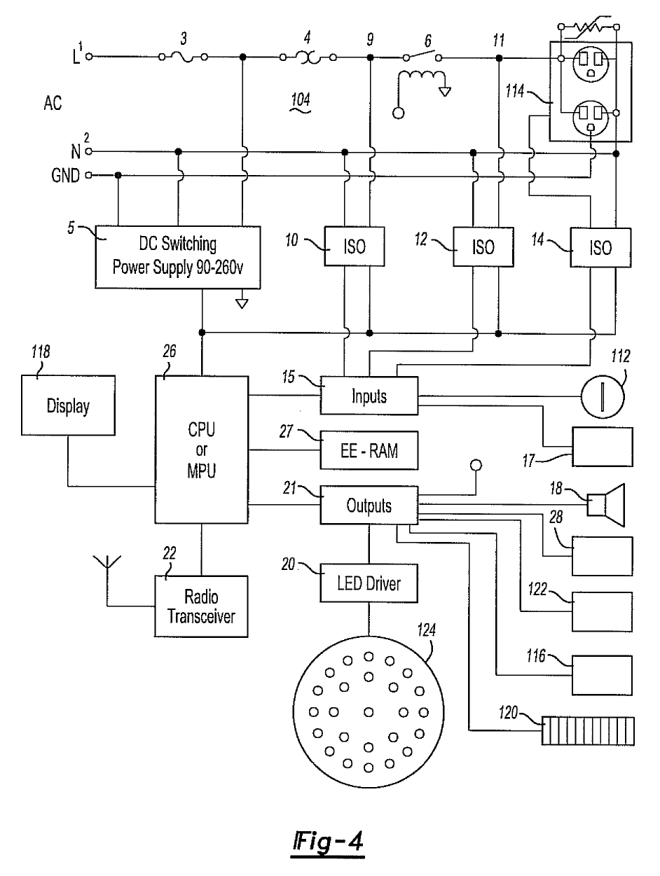

Still referring to FIGS. 1 and 4, the display panel 106 of the housing 102 may include a collection apparatus 118 that operates to receive payment from a user for use of the outlet 100. The collection apparatus 118 may be a paper currency acceptor. However, it will be appreciated that the collection apparatus 118 may also include a coin slot and bank, a card reader (for credit or debit cards), a keypad that allows a user to enter an access code, a radio frequency identification (RFID) reader or a combination of two or more of such devices.

Still referring to FIGS. 1 and 4, an LED bar graph display 120 may also be positioned on the display panel 106. The LED bar graph 120 may include an array of ten or more LEDs that are programmed by an onboard CPU (described below) to provide a user with a visual indication of the amount of time remaining during which the outlet 100 will continue to dispense current. An out of order light 122 may also be positioned on the display panel 106 to provide a user with a visual indication that an outlet 100 is out of service.

Still referring to FIGS. 1 and 4, a graphic LED or LCD display or logo 124 (described below) may be positioned on the housing to advertise or promote the outlet 100 or some other product. Alternatively, the display 124 may be used to convey an informational message.

Referring now to FIG. 4, the power management system 104 of the outlet 100 may include an AC input (1, 2). The input may be 1200 VAC or 210 VAC for overseas compliant products. In operation, it will be appreciated that the input current into the power outlet 100 may be the electrical system of the facility in which the power outlet 100 is located. A 5-amp breaker 3 available, for example, from Thermal Magnetic may also be provided for overall protection. Further, a 3-amp thermal resettable fuse 4 and an overload LED status light 28 may also be provided as a safety means. The status light 28 may be activated when the thermal fuse 4, breaker or similar device has been tripped. In this regard, if the current draw of the apparatus is more than 3 amps for two minutes, the fuse 4 will open which in turn may activate the overload light 28. After thirty seconds or when the fuse cools, the fuse 4 will reset itself and will return power to ground fault interrupter 114 plug (described below). Notably, activation of the fuse may not reset the current run time clock.

Still referring to FIG. 4, the power management system 104 may further include an AC to DC switching power supply 5. The switch 5 may have an auto ranging input supply with a range of 90-260 VAC. The output of this supply may be 5 VDC and 12 VDC. In this regard, 5 VDC may be used for a logic side of the circuit and 12 volts may be used for the LED lighting buzzer circuit and relay coil. Accordingly, it will be appreciated that the same outlet 100 may be used in an AC or DC current environment.

Still referring to FIG. 4, the power management system 104 may also include a spdt relay (6) 250 VAC, 5-amp rating and a 12-volt coil. The relay 6 may be used to switch AC current to the ground fault interrupter (GFI) plug 114 when the CPU 26 activates the coil. The GFI 114 may be used to protect consumer from faulty equipment or from children playing with the plug. Further, the GFI 114 may be easily changed from one outlet 100 to the next such that an outlet 100 can accept a different style of plug. As a result, the outlet 100 may be used in many different regions of the world.

Still referring to FIG. 4, the power management system 104 may also include an opto isolator 9, 10 to monitor the status of the thermal fuse 4. The output of the opto isolator 9, 10 may be connected to the CPU 26 so that a routine in the CPU may activate the overload status light 28 and enable piezo buzzer 18 at 30% volume and 200 ms pulse, e.g. like a chirp, every fifteen seconds until thermal fuse 4 is reset, which may then disable chirp and deactivate the overload light 28. This may also re-enable relay 6, which may then permit AC current run to the GFI 114.

Still referring to FIG. 4, the power management system 104 may further include an opto isolator 11, 12 to monitor relay 6 and confirm it is functioning and not stuck in an “on” position. The output from the opto isolator 11, 12 may be connected to the CPU 26. If the relay 6 is not functioning correctly, a subroutine may run that will activate the “out of order” light 122. Accordingly, it will be appreciated that the out of order LED light 122 itself may be controlled by the CPU 26. The routine may also log the error in a memory area of an EERAM 27 (described below).

Still referring to FIG. 4, the power management system 104 may also include an opto isolator 13, 14 to monitor the status of the GFI plug 114. The output from the opto isolator 13, 14 may be connected to the CPU 26. Accordingly, if the GFI plug 114 is tripped due to a short, a subroutine may run that will activate a “reset GFI light” 116. The GFI plug 114 may then be manually reset by the consumer using the reset button 115 to restore AC current to the GFI plug 114. When the reset is pressed on the GFI 114, the GFI light 116 may be disabled.

Still referring to FIG. 4, all of the monitoring devices of the outlet 100 may be connected at an input 15 so that they may be monitored by the CPU 26 scan rate.

Still referring to FIG. 4, as describe above, a barrel style security lock switch 112 may be used to secure the panel 108 to the housing 102 or to unlock and provide access to the interior of the housing 102 when the outlet 100 requires service. The position of the switch 112 may be monitored by the CPU 26. In the regard, the CPU 26 may log when the switch 112 has been used, e.g. time and date, in the EERAM 27 memory. This logged data may be used later in data gathering.

Still referring to FIG. 2, the outlet 100 may also include a theft sensor 17 that may take the form of an inertia device that is used to sense vibration of the housing 102. The output of the sensor 17 may be monitored by the CPU 26. Accordingly, if the housing 102 is hit or banged hard, a switch of the sensor 17 may close and cause the CPU 26 routine to run, which may enable piezo buzzer 18 to sound at 100% volume at 500 ms chirps for a predetermined time. However, if the sensor 17 does not sense vibration for ten seconds, the alarm buzzer 18 may be automatically disabled. The piezo PCB buzzer 18 may be a 12 VDC device that when given power creates a loud 2 kHz constant tone at 90 db. Further, the piezo PCB buzzer 18 may be controlled by the CPU 26.

Still referring to FIG. 4, a LED driver circuit 20, controlled by CPU 26, may be provided to supply high current for a graphic LED display or logo 124 located on the exterior of the housing 102. In this regard, the CPU 26 may run a routine that may cause LEDs to chase behind display 124 or appear in some other predetermined pattern. The lighted display 124 is thus used to advertise the apparatus so that it can be easily identified, advertise some other item or provide an informational message. A variety of preprogrammed patterns can also be used depending on status of the outlet 100. Furthermore, although an LED has been described above, it will be appreciated that other manner of displays, such as a plasma screen or LCD may also be used as a display or input device with the power outlet 100.

Still referring to FIG. 2, a radio transceiver 22 or like device may be connected to the CPU 26 and be operatable to link with another “master” CPU or “laptop” or other communication device (not shown). The laptop may be running special software that will send out an encrypted signal burst. The burst may be received by the radio transceiver 22 and forwarded to the CPU 26. In this regard, the CPU 26 may be programmed to continuously scan and look for this burst. Once the CPU 26 has received the burst, it may respond back to the laptop and will be ready for commands. Once a communication link is established, information may be collected from the outlet 100 that has been not been collected since the last upload. Such information may include, for example, values like the amount of money collected, time of use, all times accessed, tampering, faults, etc. Additionally, or alternatively, the power outlet 10 may also include a port (not shown) on the exterior of the housing that permits a programming or monitoring device (e.g., a laptop computer) to connect/link direct to the CPU 26.

Still referring to FIG. 4, as previously mentioned the collection apparatus 118 may be used to collect currency (e.g., dollar bills). Accordingly, the apparatus 118 may be operable to verify currency is correct and not counterfeit. The apparatus 118 also connects to the CPU 26, which lets the program routine know when money has been inserted or when there has been a fault. If a fault has been detected, the CPU 26 routine may then run and activate “out of order” LED 122. When currency has been accepted, the CPU 26 may run a timer routine that will enable relay 6 to let AC current to run to GFI plug 114. The relay may be enabled for a predetermined time in the routine software.

Still referring to FIGS. 1 and 2, the LED bar graph display 120 may include ten LEDs in a row that are controlled by the CPU 26. The purpose of the display 120 is to indicate the amount of time the AC current will flow to GFI 114. When currency is inserted into collection apparatus 118, the CPU 26 may start a time routine for a predetermined time that lights all LEDs in the bar graph display 120. As time counts down, one LED will be deactivated. The deactivating of the LEDs can be programmed by the CPU 26 to be divisible by predetermined constant, for example, one LED for every ten seconds. Once time is about to run out, for example when a user has one minute left, all the LEDs may flash and piezo buzzer 18 may chirp for 200 ms at 30% volume for every ten seconds of countdown.

Still referring to FIGS. 1 and 4, the reset GFI LED 116 may be used when a GFI fault has been detected by the CPU 26 routine. This LED 116 will activate when the GFI reset button 115 needs to be pressed. In addition, the piezo buzzer 18 may chirp for 100 ms at 40% volume three times to let a consumer know that there is a problem.

Referring now to FIG. 4, the CPU 26 may be a self-contained math unit, ROM, RAM such as, for example, a PIC processor. The CPU 26 may include routines programmed to operate or monitor the power supply system 104. Software for the CPU 26 can be chanced or revised at any time. Revision or bug fixes can also be accomplished by removing the PIC processor and replacing it with a new one. This is a great security feature in that a PIC processor cannot be copied by unauthorized persons.

Still referring to FIG. 4, the EERAM 27 (electrical erasable read access memory) may be used to store all transactions or any faults that occur. EERAM memory does not require power to hold its memory data and it may have a retention span of about 200 years. Furthermore, EERAM may be written to over 100,000 times.

As mentioned above and shown in FIG. 4, the overload LED status light 28 may be used for when thermal fuse 4 has been tripped. LED may stay lit until fuse 4 resets itself. If fuse 4 does not reset itself, a watchdog timer routine in CPU 26 may then disable relay 6 and enable “out of order” LED 122. This fault may then be stored in the EERAM for historical data purposes and repair.

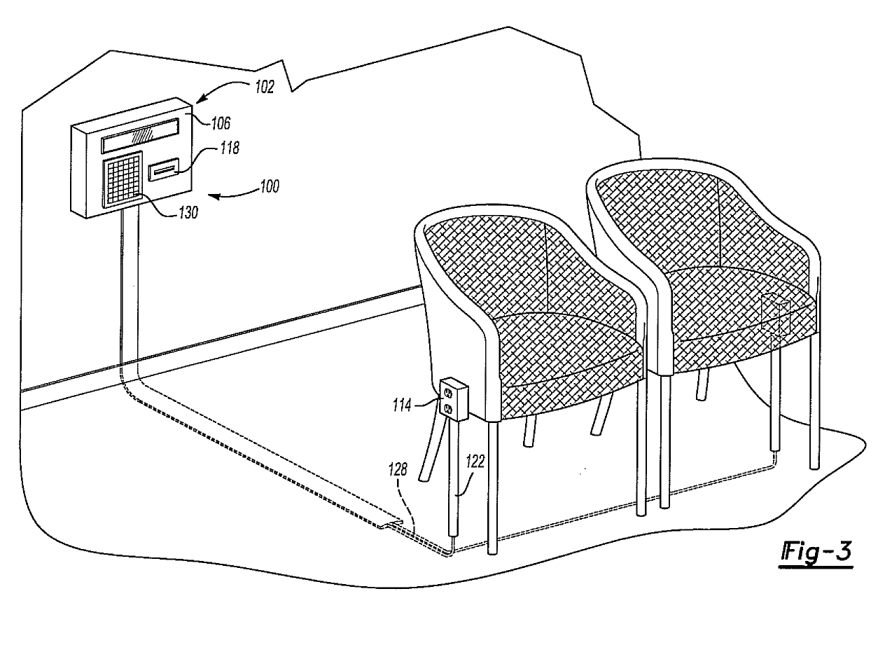

Referring now to FIG. 3, there is shown a further embodiment on a power outlet 100 in which the electrical receptacle or ground fault interrupt plug 114 may be positioned proximate a seat 30 and remote from the housing 102. Specifically, rather that being integrated into housing 102 of the power outlet 100, the electrical receptacle or ground fault interrupt plug 114 may be positioned proximate a seat 30 on, for example, a conduit post 126, and connected to the housing 102 of power out by a cable 128. The cable 128 may be a standard electrical cable that is run across a floor or carpeting between and the housing 102 and the plug 114 and that may be covered (as is known) to prevent tripping, etc. Alternatively, the cable 128 may be a cable such as those described in U.S. Pat. No. 6,492,595 or U.S. Published Application No. 2005/0042942, or any other manner of cable or connector that may be run underneath flooring or carpeting.

Still referring to FIG. 3, that power outlet 100 may also include an interface in communication with the CPU, such as a keypad 130, plasma screen, or LCD screen, that may permit a user to indicate which electrical receptacle or ground fault interrupt plug 114 should be activated to receive current. It will be appreciated that, as mentioned above, the keypad 130 may be part of the collection apparatus 118. Further, it will also be appreciated that a single power outlet 100 may be used to control one or more onboard or remotely positioned electrical receptacle or ground fault interrupt plugs 114.

Having thus described our invention, we claim:

1. A pay for use power outlet comprising:
a housing;
a power management system disposed within the housing, the power management system including a transceiver apparatus;
a collection apparatus in communication with the power management system; and
an electrical outlet in electrical communication with the power management system.

2. The pay for use power outlet of claim 1, wherein the electrical outlet is positioned on the housing

3. The pay for use power outlet of claim 1, wherein the electrical outlet is positioned remote from the housing.

4. The pay for use power outlet of claim it wherein the electrical outlet is a ground fault interrupter plug.

5. The pay for use power outlet of claim 1, wherein the collection apparatus is selected from a group consisting of a coin slot and bank, a card reader, a keypad, and a radio frequency identification (RFID) reader.

6. The pay for use power outlet of claim 1, wherein the power management system comprises an AC to DC switching power supply.

7. The pay for use power outlet of claim 6, wherein the AC to DC switching power supply has an auto ranging input supply with a range of 90-260 VAC.

8. The pay for use power outlet of claim 1, wherein the power management system comprises a memory apparatus.

9. The pay for use power outlet of claim 1, wherein the memory apparatus comprises an electrical erasable read access memory.

10. The pay for use power outlet of claim 1, wherein the power management system comprises a theft sensor.

11. The pay for use power outlet of claim 1, wherein the theft sensor comprises an inertia device.

12. The pay for use power outlet of claim 1, further comprising a light display positioned on the housing, the light display being operable to indicate the amount of time electrical current will flow to the electrical outlet.

13. The pay for use power outlet of claim 1, further comprising a graphic display positioned on the housing.

14. A pay for use power outlet comprising:
a housing;
a power management system disposed within the housing, the power management system including an AC to DC switching power supply;
a collection apparatus in communication with the power management system; and
an electrical outlet in electrical communication with the power management system.

15. The pay for use power outlet of claim 14, wherein the electrical outlet is positioned on the housing

16. The pay for use power outlet of claim 14, wherein the electrical outlet is positioned remote from the housing.

17. The pay for use power outlet of claim 14, wherein the electrical outlet is a ground fault interrupter plug.

18. The pay for use power outlet of claim 14, wherein the power management system further comprises a transceiver apparatus.

19. A pay for use power outlet comprising:
a housing;
a power management system disposed within the housing, the power management system;
a collection apparatus in communication with the power management system; and
an electrical outlet positioned remote from the housing in electrical communication with the power management system.

20. The pay for use power outlet of claim 19, wherein the power management system further comprises a transceiver apparatus and an AC to DC switching power supply.
